(19) United States
(12) Patent Application Publication
(10) Pub. No.: US 2014/0164948 A1
(43) Pub. Date: Jun. 12, 2014

(54) REMOTE COLLABORATIVE DIAGNOSIS METHOD AND SYSTEM USING MESSENGER-BASED MEDICAL IMAGE SHARING SCHEME

(71) Applicant: Infinitt Healthcare Co. Ltd., Seoul (KR)

(72) Inventors: Hyung Tae Joo, Seoul (KR); Kyo Bum Ku, Seoul (KR)

(73) Assignee: INFINITT HEALTHCARE CO. LTD., Seoul (KR)

(21) Appl. No.: 14/103,426

(22) Filed: Dec. 11, 2013

(30) Foreign Application Priority Data
Dec. 12, 2012 (KR) 10-2012-0144285

(51) Int. Cl. H04L 12/58; G06F 3/048

(52) U.S. Cl. CPC H04L 51/10; G06F 3/048
USPC 715/752

(57) ABSTRACT

Disclosed are a messenger-based medical image sharing method and system. The messenger-based medical image sharing system includes a first viewer configured to include a messenger, and to transmit information about a link to a first medical image displayed on a screen via this messenger; a second viewer configured to include a messenger, and receive the information about a link from the first viewer via this messenger, thereby sharing the first medical image, and a medical image server configured to provide the first medical image corresponding to the information about a link to the second viewer.

### CROSS-REFERENCE TO RELATED APPLICATION

This application claims under 35 U.S.C. §119(a) the benefit of Korean Application No. 10-2012-0144285 filed Dec. 12, 2012, which is incorporated herein by reference.

### TECHNICAL FIELD

The present invention relates, in general, to remote collaborative diagnosis based on medical image sharing and, more particularly, to a remote collaborative diagnosis method and system using a messenger-based medical image sharing scheme, which are capable of sharing medical images for remote collaborative diagnoses via messengers that are provided in viewers.

### BACKGROUND ART

Most people visit hospitals because of various types of serious or minor diseases or for other reasons. Although an overall process can be smoothly performed in a hospital and the process can be dealt with based on the opinions of a small number of medical experts, cases where a plurality of medical experts should gather and exchange their opinions frequently occur.

In this case, individual medical experts work in their respective fields on their respective schedules, and thus it is very difficult for all required personnel to gather and exchange opinions in a single place at the same time.

Furthermore, all medical personnel working at actual medical sites may recognize that when opinions are exchanged via documents, problems with communication may occur in the exchange of opinions based only on documents and also it take a long time to transfer opinions.

Accordingly, a need arises to enable remote collaborative diagnoses to be easily made. As a technology capable of supporting such remote collaborative diagnoses, Korean Patent No. 10-1039001 discloses “Collaborative Diagnosis System and Method.” This patent proposes a remote collaborative diagnosis system that is capable of exchanging information via a video conference on a preset schedule.

However, the remote collaborative diagnosis system based on a video conference has no provision for the processing of various data, information and/or images. Thanks to the recent development of medical imaging technology, the diagnoses of patients are frequently made based on various medical images. As a result, in order to make more improved remote collaborative diagnoses, a user interface capable of supporting the function of adjusting, editing and processing of medical images as well as the function of simply displaying medical images is demanded.

### SUMMARY OF THE DISCLOSURE

Accordingly, the present invention has been made keeping in mind the above problems occurring in the prior art, and an object of the present invention is to provide a remote collaborative diagnosis method and system using a messenger-based medical image sharing scheme, which are capable of sharing medical images via messengers provided in the viewers of users, thereby facilitating remote collaborative diagnoses.

Still another object of the present invention is to provide a user interface that enables a plurality of users participating in a collaborative diagnosis in a remote environment to conveniently share the operation, such as expansion, reduction and the changing of direction, of a medical image displayed to the users in common, annotation, the selection of a medical image of interest from a set of various medical images, switching between a plurality of medical images displayed at the same time, 3-dimensional (3D) rendering, the results of additional processing, such as a computer aided diagnosis (CAD), and/or the like.

Still another object of the present invention is to provide a remote collaborative diagnosis method and system using a messenger-based medical image sharing scheme, which are capable of reducing data traffic between viewers and improving the security of medical images.

More specifically, this object of the present invention is to provide a remote collaborative diagnosis method and system using a messenger-based medical image sharing scheme, which transmit only information about links to medical images to be shared to the viewers of users who make collaborative diagnoses via messengers, and receive the sharing-target (in other words, target-to-share) medical images corresponding to the information about links from a medical image server for providing medical images, thereby reducing traffic between viewers, and improving the security of medical images and protecting private information because medical images are shared by the medical image server.

In accordance with an aspect of the present invention, there is provided a messenger-based medical image sharing method, including selecting, at a first viewer, at least one second user with whom a first medical image displayed on a screen will be shared via a messenger; synchronizing the first viewer with a second viewer of the selected second user via the messenger; providing, at the first viewer, the second viewer with information about a link to the first medical image displayed on the first viewer via the messenger so that the second viewer can receive the first medical image from a medical image server which provides medical images; and sharing the first medical image between the first viewer and the second viewer.

The sharing may include sharing text or voice input via any one of the two viewers with the other viewer via the messenger.

The messenger-based medical image sharing method may further include, once the first medical image has been shared, controlling the second viewer via the messenger so that a first user input of the first viewer can be applied to the first medical image displayed on the second viewer together.

The messenger-based medical image sharing method may further include, once the first medical image has been shared, performing control via the messenger so that a user input of any one of the first and second viewers can be applied to the first medical image displayed on the other viewer together.

The controlling may include, if a permission for a second user input to the first medical image has been preset, controlling via the messenger so that the input of the second user can be applied to the first viewer together.

The sharing may include sharing the first medical image with the second viewer only within a range of information sharing set by a first user of the first viewer.

The selecting may include selecting the second user from information of a plurality of users included in information about a user group preset by the first user.

In accordance with another aspect of the present invention, there is provided a messenger-based medical image sharing system, including a selection unit configured to select at least one second user with whom a first medical image displayed on a screen will be shared to be selected via a messenger provided in a first viewer; a synchronization unit configured to synchronize the first viewer with a second viewer of the selected second user via the messenger; and a sharing unit configured to provide the second viewer with information about a link to the first medical image via the messenger so that the second viewer can receive the first medical image from a medical image server which provides medical images and share the first medical image. The selection unit, the synchronization unit, the sharing unit may be a sub-module of a processor included in the messenger-based medical image sharing system. The system may be directly connected to the first viewer, and communicate with the second viewer via the messenger.

In accordance with still another aspect of the present invention, there is provided a messenger-based medical image sharing network system, including a first viewer configured to include a first messenger, and to transmit information about a link to a first medical image displayed on a screen via the first messenger; a second viewer configured to include a second messenger, and receive the information about a link from the first viewer via the first and second messengers, and share the first medical image, and a medical image server configured to provide the first medical image corresponding to the information about a link to the second viewer. The identities of the network system may be connected via an internet, and/or a wireless communication link, etc.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating the configuration of a messenger-based medical image sharing system according to an embodiment of the present invention;

FIG. 2 is a diagram illustrating the configuration of the first viewer illustrated in FIG. 1 according to an embodiment of the present invention;

FIG. 3 is a diagram illustrating an example of controlling the medical image shared between the two viewers of FIG. 1;

FIG. 4 is a diagram illustrating another example of controlling the medical image shared between the two viewers of FIG. 1;

FIG. 5 is a flowchart illustrating the process of a messenger-based medical image sharing method according to an embodiment of the present invention;

FIG. 6 is a flowchart illustrating the detailed process of step S510 illustrated in FIG. 5 according to an embodiment of the present invention;

FIG. 7 is a flowchart illustrating the additional operation of the first viewer in the messenger-based medical image sharing method according to an embodiment of the present invention; and

FIG. 8 is a flowchart illustrating the additional operation of the second viewer in the messenger-based medical image sharing method according to an embodiment of the present invention.

### DETAILED DESCRIPTION OF THE DISCLOSURE

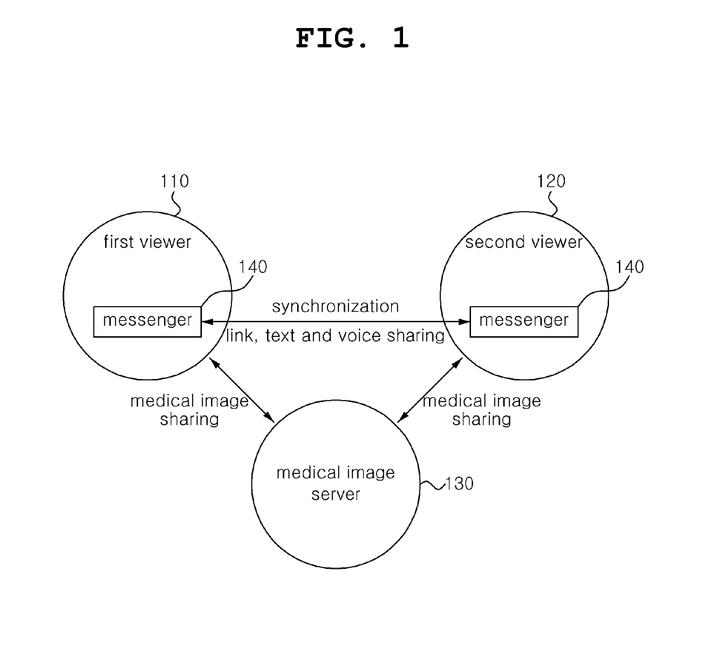

Hereinafter, embodiments of the present invention will be described in detail with reference to the accompanying drawings. Reference now should be made to the elements of drawings, in which the same reference numerals are used throughout the different drawings to designate the same elements. In the following description, detailed descriptions of known elements or functions that may unnecessarily make the gist of the present invention obscure will be omitted. A remote collaborative diagnosis method and system using a messenger-based medical image sharing scheme according to an embodiment of the present invention will be described in detail below with reference to FIGS. 1 to 8.

FIG. 1 is a diagram illustrating the configuration of a messenger-based medical image sharing system according to an embodiment of the present invention.

Referring to FIG. 1, the system according to the present invention includes a first viewer 110, a second viewer 120, and a medical image server 130. In the following detailed description of the present invention, for ease of description, the first viewer 110 is assumed to be the viewer of a user who requests medical image sharing (hereinafter referred to as the “first user”), and the second viewer 120 is assumed to be the viewer of a user who is selected by the user of the first viewer 110 (hereinafter referred to as the “second user”).

The first viewer 110 includes a messenger 140 to communicate with the messenger 140 of the second viewer 120 in order to make a collaborative diagnosis, displays a medical image on a screen, and provides information about a link to the medical image to the messenger 140 of the second viewer 120 via its own messenger 140 when the medical image is shared in response to a request from the first user. Then the second viewer may access the first medical image via the shared link. Depending on one of example of the invention, the second viewer may access the first medical image only via the shared link. In this case, the access permission of second viewer to the first medical image may be partially limited by the medical image sharing server.

In this case, the first viewer 110 may perform a synchronization process that is required to share the medical image with the second viewer 120. Once the first viewer 110 has been synchronized with the second viewer 120, the first viewer 110 may provide the information about a link to the medical image to be shared (hereinafter referred to as the “sharing-target medical image”) to the messenger 110 of the second viewer 140, and may later share the operation, text, voice, etc. of the user related to the sharing-target (or target-to-share) medical image input by the first or second user via the messenger 140. In this case, the synchronization between the first and second viewers 110 and 120 may be synchronization between the messenger of the first viewer 110 and the messenger of the second viewer 120.

The information about a link of the present invention may be generated by the first viewer 110, and may be transferred to the second viewer 120 via the messengers 140 and further to the medical image server 130. Alternatively, the information about a link may be generated by the medical image server 130, and may be provided to the first viewer 110 along with a sharing-target medical image when the sharing-target medical image is provided to the first viewer. Accordingly, the information about a link generated by the medical image server 130 may be transferred to the second viewer 120 via the messengers 140 when synchronization with the second viewer 120 is performed in response to the request of the first viewer, and the generated information about a link may be directly transferred to the second viewer 120 when synchronization is performed in the medical image server 130. It will be apparent that in order to provide the information about a link from the medical image server 130 to the second viewer 120, it is preferable to acquire information about the second viewer 120 that desires to share the medical image from the first viewer.

The messenger 140 is a real-time remote collaborative diagnosis-enabled messenger. The messenger 140 may a messenger specialized for the medical image server 130, for example, a Picture Archival and Communication System (PACS), and may includes an interface constructed to share medical images.

In this case, the messenger 140 may extract or provide two or more users corresponding to the characteristic information of the sharing-target medical image from information of a plurality of previously stored users based on the characteristic information of the sharing-target medical image, and may receive a selection of a second user who will make a remote collaborative diagnosis from the provided information of two or more users. The information of a plurality of previously stored users may be information of the users of other messengers who are connected to the messenger of the first user, or may be information of users who participate in the field related to the first user. Information about the users who participate in the related field may be provided by a server (not illustrated). The server that provides user information may update the information about users at regular time intervals and then provide the updated information. The provided information about users may include information about the priorities of the respective users in the related field. If the priorities of the respective users have been determined, the messenger 140 may extract at least one user from information of a plurality of users based on the priorities, and may additionally take into consideration the characteristic information of the sharing-target medical image.

In this case, the characteristic information of the sharing-target medical image may include the type of medical imaging apparatus that has captured the sharing-target medical image, for example, a computerized tomography (CT) scanner, a magnetic resonance imaging (MRI) scanner, a positron emission tomography (PET) scanner or an X-ray machine, a captured bodily region, a region of interest in the sharing-target medical image, a field related to the sharing-target medical image, etc.

In accordance with another embodiment, a method of providing at least one user who will make a collaborative diagnosis selected from information of a plurality of users may provide at least one user based on not only the characteristic information of a sharing-target medical image but also information about the first user of the first viewer 110.

In this case, the information about the first user may include the department, professional field (for example, specialized cancer treatment) etc. of the first user, and may also include all user information required for a collaborative diagnosis.

Alternatively, the method of providing at least one user who will make a collaborative diagnosis selected from information of a plurality of users may be performed in such a way that information about a user group of users preset by the first user is acquired and the first user selects a second user from information of users included in the acquired group information.

In this case, a list of users included in the user group may be added, deleted and changed by the first user, and an interface for performing this function may be included in a viewer or messenger. In this case, the acquired information about a user group may be information about a user group to which the first user belongs.

Furthermore, when a collaborative diagnosis related to a medical image is requested from another department to which the first user does not belong, an interface capable of selecting user group information related to the department from which the collaborative diagnosis is requested to be selected and also selecting a second user to be selected from information of users included in the user group information may be provided to the first user via the viewers or messengers.

In this case, the user group information related to the department another department may be received from the server through communication with the server.

Furthermore, the first user of the first viewer 110 may set the range of sharing, a sharing-target medical image control method, operation control authorities, etc. via the interface provided in the messenger or the interface provided in the viewer.

In this case, the operation control authorities may include not only the authority to perform user input related to a sharing-target medical image but also the authority to perform annotation, windowing, and rendering. That is, the first user may set the range of information sharing related to a sharing-target medical image, access authority, operation control, etc. when a collaborative diagnosis is made.

For example, via the interface provided in the first viewer 110 or messenger 140, the first user may select, edit and designate a region of interest, and may, in regard to a sharing-target medical image control method, (1) make a setting so that a counterparty, that is, the second user of the second viewer 120, can freely adjust a sharing-target medical image by adjusting the field of view or an angle or performing zoom-in, zoom-out, or the like, or (2) may make a setting so that a counterparty cannot adjust or edit a sharing-target medical image.

In this case, the case (1) may be a case set so that input of the second user (which applies to the displayed first medical image) can be permitted, the case (2) may be a case set so that input of the second user can be not permitted(therefore the second user cannot edit the displayed first medical image).

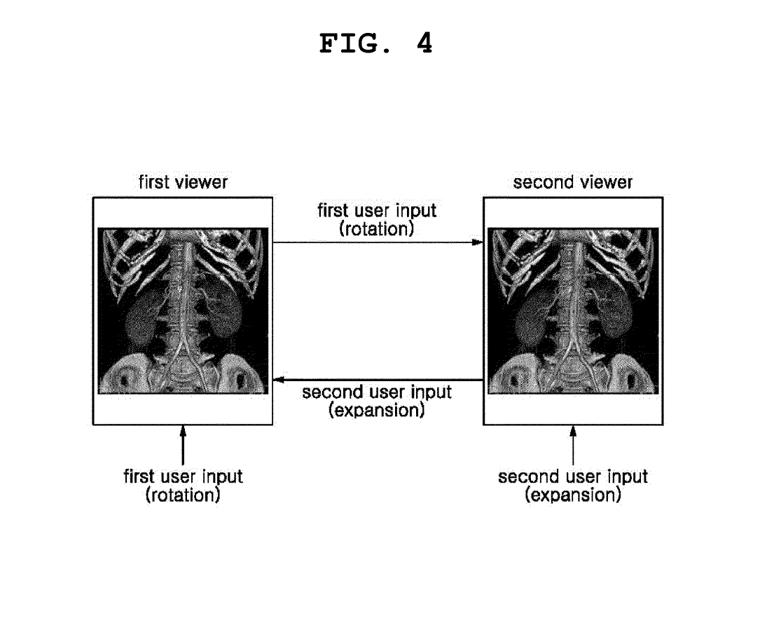

If the sharing-target medical image control method has been set to the case (1) by the first user, an operation input by the first user of the first viewer 110 may be provided as the user input of the sharing-target medical image displayed on the second viewer 120, and an operation input by the second user of the second viewer 120 may be provided as the user input of the sharing-target medical image displayed on the first viewer 110. For example, as illustrated in FIG. 4, when the first user of the first viewer 110 performs an operation of rotating a sharing-target medical image, a first user input related to the rotation is provided as the user input of the second viewer 120 via the messengers, thereby rotating the sharing-target medical image displayed on the second viewer 120. In the same manner, when the second user of the second viewer 120 performs an operation of expanding a sharing-target medical image, a second user input related to the expansion is provided as the user input of the first viewer 110 via the messengers, thereby expanding the sharing-target medical image displayed on the first viewer 110.

That is, a user operation input via any one of the viewers may influence the other viewer.

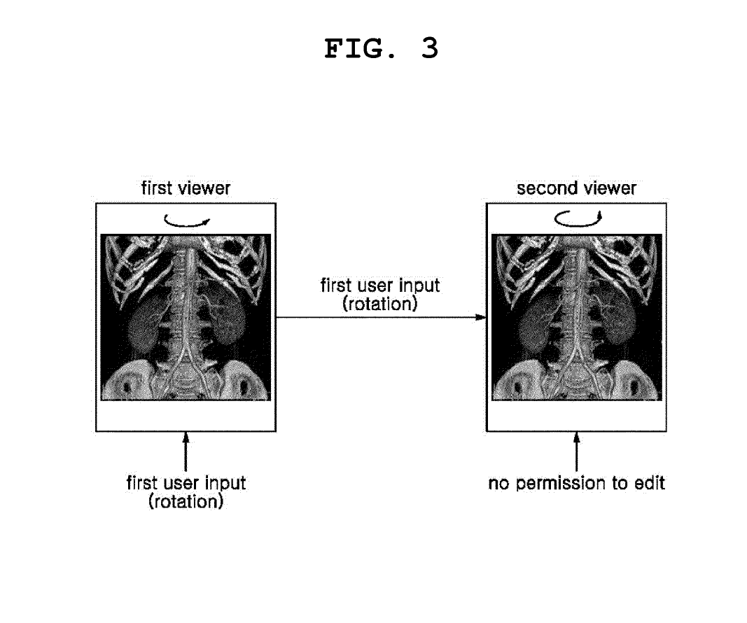

In contrast, when the sharing-target medical image control method has been set to the case (2) by the first user, only an operation input by the first user of the first viewer 110 may be provided as the user input of a sharing-target medical image displayed on the second viewer 120, and the second user of the second viewer 120 cannot perform any operation on the sharing-target medical image. For example, as illustrated in FIG. 3, when the first user of the first viewer 110 performs an operation of rotating a sharing-target medical image, a first user input related to the rotation is provided as the user input of the second viewer 120 via the messengers, thereby rotating the sharing-target medical image displayed on the second viewer 120. In contrast, the second user of the second viewer 120 cannot provide any input to the first viewer 110 because he or she cannot adjust or edit the sharing-target medical image.

That is, only a user operation input by the first user who has requested sharing may influence the second viewer.

It will be apparent that even in the cases of FIGS. 3 and 4, text or voice may be shared between the first and second users via the messengers.

Furthermore, the first user of the first viewer 110 may set whether to allow the sharing of information included in a sharing-target medical image, for example, information about annotation, windowing, rendering, etc. when sharing the sharing-target medical image.

The second viewer 120 is the viewer of the second user that communicates with the first viewer 110 in order to make a collaborative diagnosis. The second viewer 120 is requested to perform a collaborative diagnosis by the first viewer 110 via the messenger of the first viewer 110 and the messenger of the second viewer 120, accepts the request, performs a synchronization process, and then receives information about a link to a sharing-target medical image from the messenger of the first viewer 110, thereby receiving the sharing-target medical image corresponding to the information about a link from the medical image server 130 and then displaying the sharing-target medical image on the screen.

In this case, via the messenger of the second viewer 120, the second user may additionally share text or voice with the first user of the first viewer 110, and may also share first user input and second user input depending on information about the sharing-target medical image or sharing information set by the first user. It will be apparent that the sharing of the second user input is possible when information indicating that the second user is allowed (or permitted) to adjust a sharing-target medical image included in setting information related to the sharing-target medical image.

Result data, for example, a sharing-target medical image manipulated through user input, annotation, windowing and rendering input by the first and/or second users, etc., which are acquired by the collaborative diagnosis via the first and second viewers 110 and 120, may be stored in the first and/or second viewers or in the medical image server 130. It is preferable for the protection and safety of information to store the result data in the medical image server 130. It will be apparent that collaborative diagnosis result data may be stored in response to a request from the first user, and may be stored in response to a request from the second user if the second user has storage-related authority. That is, the first and second users who make a collaborative diagnosis are users having the authority to read a sharing-target medical image, and may update data of the medical image server 130 with result data related to the sharing-target medical image. It is preferred that the first user who has requested the collaborative diagnosis update data with the collaborative diagnosis result data related to the sharing-target medical image.

The medical image server 130 is a server that provides a medical image to the first and second viewers 110 and 120. The medical image server 130 may correspond to, for example, a PACS. The medical image server 130 provides a sharing-target medical image corresponding to information about a link shared through synchronization to the second viewer 120. It will be apparent that the medical image server 130 may provide a sharing-target medical image corresponding to information about a link to the second viewer 120 in response to a request from the second user of the second viewer 120.

Furthermore, the medical image server 130 may store collaborative diagnosis result data related to the sharing-target medical image. For example, the medical image server 130 may store image and text result data, for example, annotation, windowing and rendering data related to the sharing-target medical image, acquired via the collaborative diagnosis of the first and second users. Such collaborative diagnosis result data may be stored in a database table that has been mapped to the corresponding image data.

Moreover, the medical image server 130 may provide the collaborative diagnosis result data stored in the database table for reference when the corresponding sharing-target medical image is read in the future.

As described above, the system according to the present invention can share a sharing-target medical image displayed on the viewer of a user by transmitting information about a link to the medical image for a collaborative diagnosis via the messengers provided in the viewers, so that traffic between the messengers, that is, the viewers, can be reduced because only the information about a link is transmitted and received via the messengers, the security of the medical image and the protection of private information can be improved because the medical image is shared via the medical image server, and the traffic of the medical image server can be also reduced because the collaborative diagnosis is performed via the messengers.

Although FIG. 1 illustrates that the first user of the first viewer requests a collaborative diagnosis, the second user of the second viewer accepts the request and thus a medical image is shared, the present invention is not limited thereto, and vice versa. Furthermore, after the first viewer and the second viewer have been synchronized with each other, the first or second user provides information about a link to a new medical image to the messenger of a counterparty, thereby enabling the new medical image to be shared.

In FIG. 1, the embodiment in which the screen of the results of operations, for example, rotation, performed on an image being shared between users participating in a remote collaborative diagnosis is shared has been illustrated. However, it will be apparent that the spirit of the present invention is not limited to this embodiment. In another embodiment of the present invention, the results of operations, for example, expansion, reduction, the changing of direction (the changing of a view point), and rotation, performed on an image being shared between users participating in a remote collaborative diagnosis may be synchronized and shared. Furthermore, the annotation information of any one user related to a shared image may be displayed to other users in a synchronized state. When any one user has selected a medical image of interest from a set of various medical images, the results of the selection may be provided to other users. When a plurality of medical images is displayed, the results of switching between screens performed by any one user may be also provided to other users.

Meanwhile, an operation, such as the rotation, expansion or reduction of an image, performed in response to a request from a user may be performed on 3D medical images obtained by 3D rendering, and may also be performed on two-dimensional (2D) medical images, such as CT and MRI tomographic slice images, sagittal, coronal and axial images, multi-planar reformatting (MPR) images, etc.

Furthermore, the results of additional processing performed in response to a request from any one user may be shared with other users. Examples of additional processing include 3D rendering, segmentation related to a Region of Interest (ROI), such as a tumor, and a CAD.

An operation, the addition of an annotation, the selection of an image, the switching between screens, additional processing, and/or the like may be executed by the medical image server 130 in response to a request from any one user. The results of the execution may be shared among the viewers of a plurality of users.

In this case, when an operation, the addition of an annotation, the selection of an image, a request for the switching between screens, or a request for additional processing is input by any one user via a user interface, the system according to the present invention may additionally provide a confirmation menu that is used to check whether to share the processing results of the request with other users. The confirmation menu may be selectively provided by taking into consideration factors, such as the processing cost of a user request, resources for the processing of the user request, and/or the processing time of the user request. That is, the confirmation menu that is used to check whether to share the processing results of the request with other users is provided if the user request occupies many resources or requires a long processing time, and the processing results of the request may be shared with other users without providing the confirmation menu if the user request can be immediately processed.

In contrast, the confirmation menu that is used to check whether to share the processing results of a user request with other users may be provided depending on whether a user request is closely related to the private information of a patient, rather than depending on the processing cost, resources and processing time of the user request. In this case, even for the same screen operation, whether to provide the confirmation menu may be determined depending on the type of lesion or organ that is related to a user request.

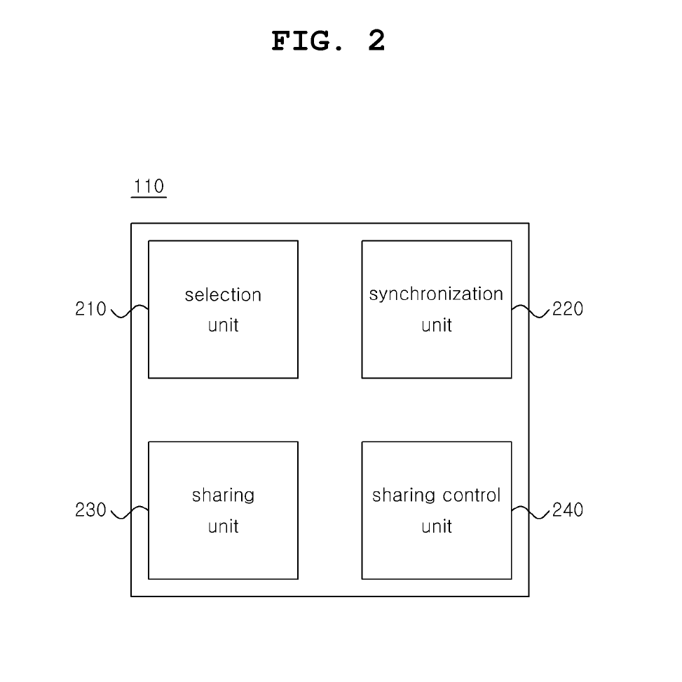

FIG. 2 is a diagram illustrating the configuration of the first viewer illustrated in FIG. 1 according to an embodiment of the present invention. Although only the configuration of the first viewer has been illustrated in this drawing, the second viewer may include the same configuration.

Referring to FIG. 2, the first viewer 110 includes a selection unit 210, a synchronization unit 220, a sharing unit 230, and a sharing control unit 240. Although not illustrated in FIG. 2, the first viewer 110 may include a messenger, as illustrated in FIG. 1. Corresponding to the example of invention, the selection unit 210, the synchronization unit 220, the sharing unit 230, and the sharing control unit 240 may be included a processor (not shown) which is embodied with the first viewer 110. The selection unit 210, the synchronization unit 220, the sharing unit 230, and the sharing control unit 240 may be functional sub-modules of the processor(not shown).

The selection unit 210 enables (or selects) a second user who makes a remote collaborative diagnosis while sharing a medical image displayed on a screen to be selected via the messenger provided in the first viewer.

In this case, the selection unit 210 may be a function provided in the messenger. The selection unit 210 provides information of one or more users corresponding to the characteristic information of the sharing-target medical image from information of a plurality of previously stored users, and allows a user, that is, the first user, to select the second user who will make a remote collaborative diagnosis.

In this case, the selection unit 210 may extract and provide information of at least one user to the first user based on not only the characteristic information of the sharing-target medical image but also at least one of previously stored information including information about the department and professional field of the first user and information about a plurality of individual users. Furthermore, the at least one user may be extracted by further taking into consideration history information indicating that the first user has selected other users in order to make collaborative diagnoses. It will be apparent that the history information may include the characteristic information of sharing-target medical images, information about individual selected users, and collaborative diagnosis-related information.

Furthermore, the selection unit 210 may select the second user from information of users included in information about a group of users preset by the first user.

In this case, although the selection unit 210 may basically receive information about a group to which the first user belongs and then select the second user, there may be cases where a collaborative diagnosis related to a medical image is requested from another department to which the first user does not belong. In this case, the second user may be selected using information about a group selected via an interface capable of selecting information about a group related to a department from which a collaborative diagnosis will be requested. It will be apparent that the selection of the second user may be performed through the input of the first user.

The synchronization unit 220 synchronizes the first viewer with the viewer, that is, the second viewer, of the second user selected by the selection unit 210 using the messengers provided in the respective viewers.

In this case, the synchronization unit 220 may synchronize the first viewer with the second viewer by synchronizing the messenger of the first viewer with the messenger of the second viewer. The synchronization may include not only synchronization related to a medical image but also synchronization related to operations of manipulating the sharing-target medical image, text input, and voice input made by the first and second users.

Once the synchronization has been achieved by the synchronization unit 220, the sharing unit 230 provides information about a link to the sharing-target medical image displayed on the screen of the first viewer to the second viewer of the second user via the messengers, thereby enabling the second viewer to receive the sharing-target medical image corresponding to the information about a link from the medical image server and to share the sharing-target medical image.

In this case, although the sharing-target medical images displayed on the first and second viewers may vary in angle or rotation at the time at which the sharing-target medical image is shared via the sharing unit 230, the angle and rotation of the sharing-target medical images may be made uniform through messenger synchronization between the two viewer at the time at which the sharing-target medical image is displayed on the second viewer.

Furthermore, the sharing unit 230 may allow not only the sharing of the sharing-target medical image but also the sharing of text, for example, a user's comments on the sharing-target medical image and voice, for example, opinions on the sharing-target medical image, input by the users of the two viewers.

Furthermore, the sharing unit 230 may allow the sharing of information about the sharing-target medical image within the range of sharing set by the first user. It will be apparent that the sharing of information within the range of sharing may be controlled by the sharing control unit 240.

The sharing control unit 240 provides the user input of the first user to the second viewer via the messengers after the sharing-target medical image has been shared, thereby controlling the sharing-target medical image displayed on the second viewer. That is, the sharing control unit 240 provides the operation of the first user related to the sharing-target medical image to the second viewer via the messengers, thereby controlling the sharing-target medical image displayed on the second viewer together.

Furthermore, the sharing control unit 240 may receive the operation of the second user related to the sharing-target medical image from the messenger of the second viewer based on information about the sharing of the sharing-target medical image or setting information set via the interface of the first viewer or messenger, and may control the sharing-target medical image in accordance with the received operation of the second user when the operation of the second user is received.

In this case, information about the sharing of the sharing-target medical image may include information about whether the second user can adjust and/or edit the sharing-target medical image, the ranges of adjustment and/or editing, the range of the sharing of the sharing-target medical image, etc.

In accordance with the present invention, an interface for sharing medical images is constructed in the messenger, and medical images are shared with a counterparty via the interface, thereby facilitating the sharing of medical images and the making of collaborative diagnoses.

Although user input via any one of the first and second viewers is described as being provided to the other viewer via the messengers in the detailed description of the invention, the present invention is not limited thereto. A change in the sharing-target medical image attributable to user input may be processed by the medical image server and provided to a corresponding viewer, and the processing results may be provided directly to the other viewer. In this case, the medical image server may provide information about a link to a processed sharing-target medical image to each viewer. Alternatively, the medical image server may provide information about a link to a processed sharing-target medical image to any one of the views that has requested processing and the viewer may provide the information to the other viewer, thereby enabling the other viewer to receive the changed sharing-target medical image from the medical image server.

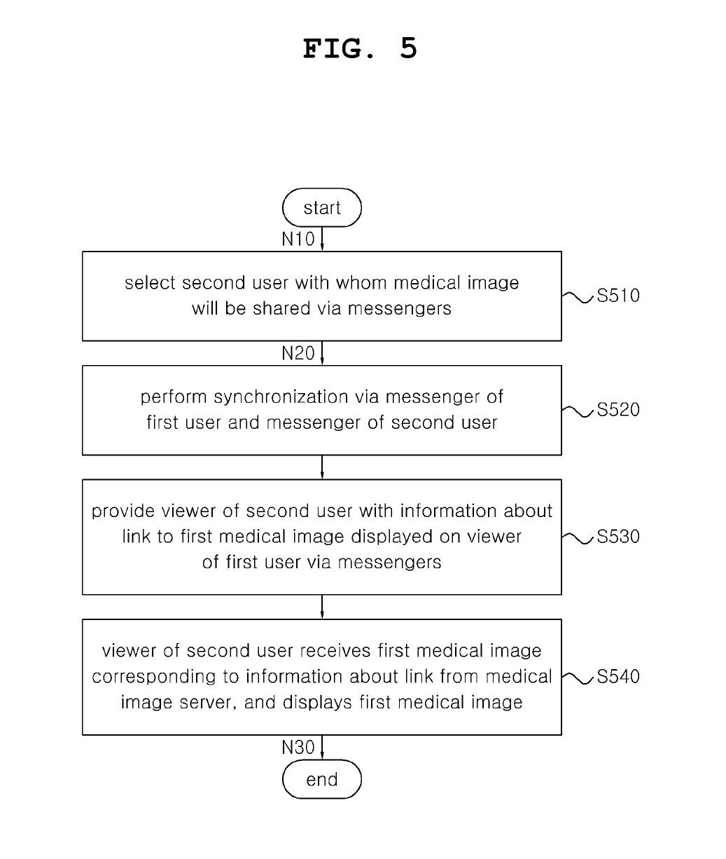

FIG. 5 is a flowchart illustrating the process of a messenger-based medical image sharing method according to an embodiment of the present invention.

Referring to FIG. 5, in accordance with the messenger-based medical image sharing method according to the embodiment of the present invention, a second user with whom a medical image will be shared is selected via a messenger provided in a viewer, that is, in this case, the first viewer 110 illustrated in FIG. 1, at step S510.

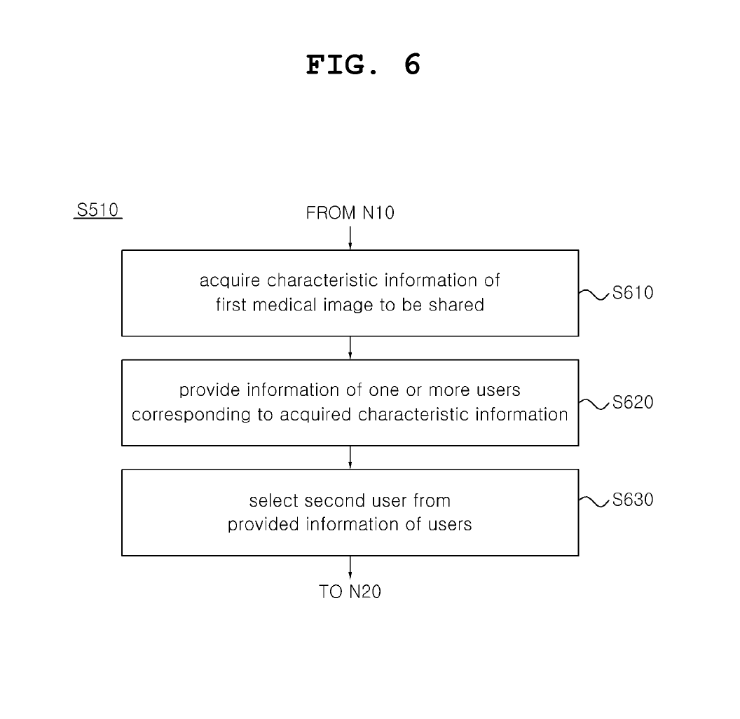

In greater detail, at step S510, as illustrated in FIG. 6, the characteristic information of a sharing-target medical image (a first medical image) to be shared may be acquired from the sharing-target medical image itself or from the medical image server and information of one or more users corresponding to the acquired characteristic information of the sharing-target medical image may be provided (see steps S610 and S620).

In this case, at step S620, information of one or more users corresponding to the characteristic information from information of a plurality of previously stored users may be provided. The information of a plurality of users may be information of users that are connected to the messenger of the first user, or may be information of users that are received from a separate server for providing user information and then stored.

When the information of one or more users are provided at step S620, the first user selects a second user, who makes a collaborative diagnosis together, from the information of one or more users while sharing the sharing-target medical image at step S630.

As illustrated in FIG. 6, at step S510 of selecting a second user, information of at least one user may be provided by taking into consideration the characteristic information of the sharing-target medical image to be shared, for example, the type of medical imaging apparatus that has captured the sharing-target medical image, a captured bodily region, a region of interest in the sharing-target medical image, a sharing-target medical image-related field, and/or the like.

Alternatively, at step S510 of selecting a second user, the information of at least one user may be provided by taking into consideration previously stored user information about a plurality of individual users, for example, related fields and/or priorities in the related fields. Alternatively, at the information of least one user may be provided by taking into consideration information about the first user, for example, the department and/or professional field of the user. Alternatively, at step S510 of selecting a second user, history information may be further taken into consideration. The history information may be information of each of one or more second users previously selected by the first user.

Alternatively, at step S510 of selecting a second user, the second user may be selected from information of users included in information about a group of users preset by the first user. The information about a group may basically be information about a group to which the first user belongs, or may be information about a group related to another department to which the first user does not belong if the department is selected via the interface.

Referring to FIG. 5 again, once the second user has been selected at step S510, synchronization is performed via the messenger of the first user, that is, a user who requests a collaborative diagnosis, and the messenger of the second user at step S520.

In this case, the synchronization may be synchronization between the viewer of the first user and the viewer of the second user, or synchronization between the messenger of the first user and the messenger of the second user.

Once the two viewers have been synchronized, information about a link to the sharing-target medical image (the first medical image) displayed on the viewer of the first user is provided to the viewer of the second users via the messengers, and the viewer of the second user, that is, the second viewer 120 illustrated in FIG. 1, requests the sharing-target medical image (first medical image) corresponding to the information about a link from the medical image server, for example, a PACS, receives the sharing-target medical image (first medical image) and displays the sharing-target medical image (first medical image) on the screen at steps S530 and S540.

As described above, once the two viewers have been synchronized and the sharing-target medical image has been shared based on the information about a link, text information or voice information input by the first or second user may be additionally shared via the messengers. In this case, the text information and the voice information may be shared directly between the viewers via the messengers, and may be shared via the medical image server. The shared text and voice information may be stored in the medical image server along with the sharing-target medical image.

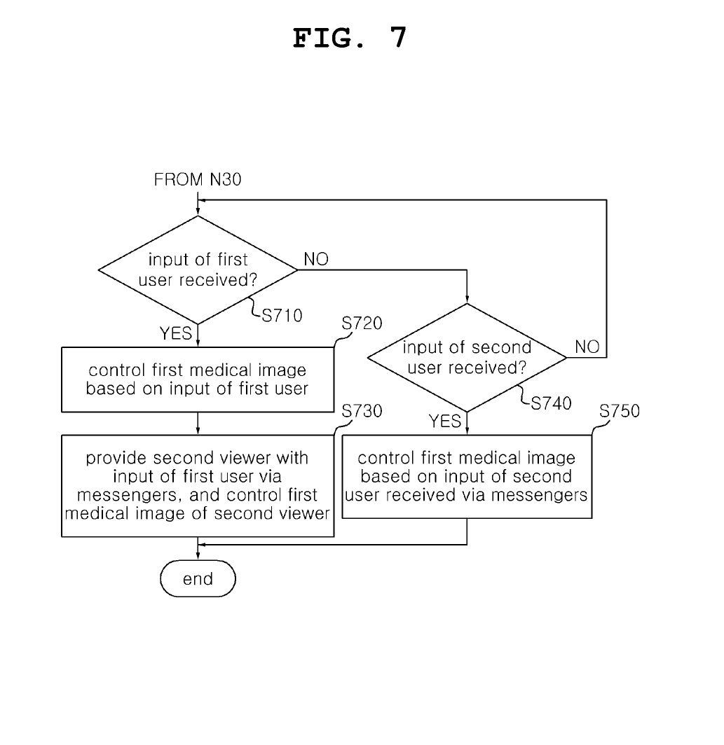

FIG. 7 is a flowchart illustrating the additional operation of the first viewer in the messenger-based medical image sharing method according to an embodiment of the present invention.

Referring to FIG. 7, once the sharing-target medical image has been shared between the two viewers, the first viewer determines whether the operation of the first user, that is, input of the first user, has been received at step S710, the operation of the sharing-target medical image (first medical image) displayed on the first viewer is controlled in response to the input of the first user if the input of the first user has been received at step S720, and the input of the first user is provided to the viewer of the second viewer via the messengers, thereby also controlling the operation of the sharing-target medical image displayed on the second viewer at step S730.

In contrast, if, as a result of the determination at step S710, it is determined that the input of the first user has not been received, it is determined whether the input of the user of the second viewer, that is, the second user, has been received via the messengers at step S740.

If, as a result of the determination at step S740, it is determined that the input of the second user has not been received, step S710 is performed again. If the input of the second user has been received, the operation of the sharing-target medical image displayed on the first viewer is controlled in response to the input of the second user received by the first viewer via the messenger at step S750.

That is, steps S740 and S750 are related to the case where a counterparty that makes a collaborative diagnosis can perform user input. This case corresponds to the case where the first user has made a setting so that the second user can adjust and/or edit the sharing-target medical image. In other words, the case corresponds to the case where the second user also has the authority to control the operation of the sharing-target medical image. If the first user has made a setting so that the second user cannot adjust or edit the sharing-target medical image, steps S740 and S750 are not performed because the input of the second user is not received from the second viewer.

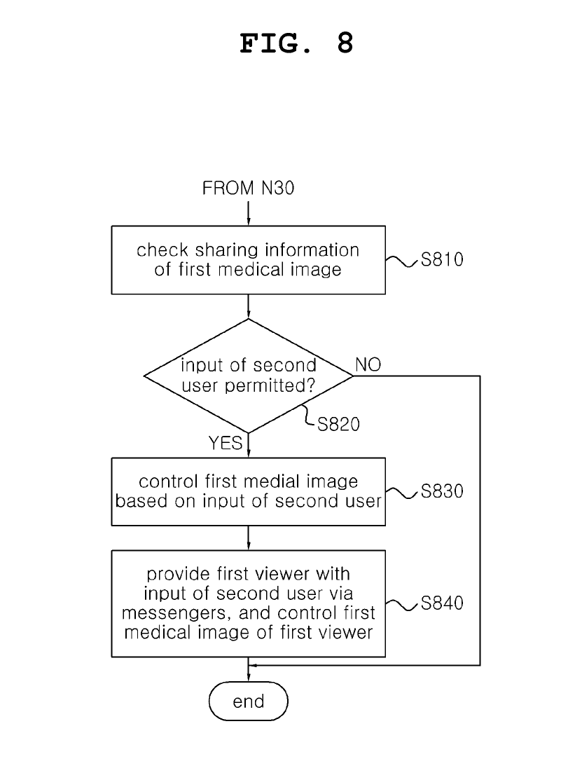

FIG. 8 is a flowchart illustrating the additional operation of the second viewer in the messenger-based medical image sharing method according to an embodiment of the present invention.

Referring to FIG. 8, once the sharing-target medical image has been shared between the two viewers, the second viewer checks information about the sharing of the sharing-target medical image (first medical image) at step S810, and determines whether the second user can be permitted input based on the checked information about the sharing at step S820.

In this case, the information about the sharing of the sharing-target medical image is information set for the sharing-target medical image by the first user of the first viewer. The information about the sharing of the sharing-target medical image may include information about a setting that allows only the first user to adjust and/or edit the sharing-target medical image or a setting that allows the second user to adjust and/or the sharing-target medical image. This information may be acquired from the sharing-target medical image or medical image server.

If, as a result of the determination at step S820, it is determined that input of the second user can be permitted, the operation of the sharing-target medical image (first medical image) displayed on the second viewer is controlled in response to the input of the second user at step S830, and the input of the second user is provided to the first viewer via the messengers, thereby controlling the operation of the sharing-target medical image displayed on the first viewer at step S840.

In contrast, if, as a result of the determination at step S820, it is determined that input of the second user cannot be permitted, that is, if the sharing-target medical image cannot be adjusted and/or edited by the second user, any operation cannot be performed on the sharing-target medical image, and the second user may be notified of this if necessary.

The remote collaborative diagnosis method using a messenger-based medical image sharing scheme according to the embodiment of the present invention may be implemented in the form of program instructions that are executable by various types of computer means, and may be recorded in a computer-readable storage medium. The computer-readable storage medium may include program instructions, data files, and data structures either independently or in combination. The program instructions stored in the medium may be designed and configured especially for the present invention or may be known to and usable by those skilled in the art of computer software. Examples of the computer-readable storage medium may include a magnetic medium, such as a hard disk, a floppy disk, or magnetic tape, an optical medium, such as CD-ROM or a DVD, a magneto-optical medium, such as a floptical disk, and a hardware apparatus, such as ROM, RAM, or flash memory which is especially configured to store and execute the program instructions. Examples of the program instructions include not only such machine language code that is created by a compiler, but also such high-level language code that is executable by a computer using an interpreter or the like. The hardware apparatus can be configured to function as one or more software modules so as to perform the operation of the present invention, and vice versa.

The remote collaborative diagnosis method and system using a messenger-based medical image sharing scheme according to the present invention have the advantages of sharing medical images via messengers provided in the viewers of users, facilitating remote collaborative diagnoses through the sharing of the medical images, and sharing medical images through the transmission and reception of information about links corresponding to the medical images via the messengers, thereby reducing data traffic between viewers and improving the security of medical images.

More specifically, the remote collaborative diagnosis method and system using a messenger-based medical image sharing scheme according to the present invention have the advantages of transmitting only information about a link to a medical image to be shared to the viewers of users who make a collaborative diagnosis via messengers, and receiving the sharing-target medical image corresponding to the information about a link from a medical image server for providing medical images, thereby reducing traffic between viewers, and improving the security of medical images and protecting private information because medical images are shared by the medical image server.

Furthermore, the present invention has the advantages of constructing an interface for sharing medical images in the messenger and enabling users with whom medical images will be shared to be easily selected via the interface, thereby facilitating the sharing of medical images and the making of remote collaborative diagnoses.

Moreover, the present invention has the advantage of enabling a plurality of users participating in a collaborative diagnosis in a remote environment to conveniently share the operations, such as expansion, reduction and the changing of direction, of a medical image displayed to the users in common, annotation, the selection of a medical image of interest from a set of various medical images, switching between a plurality of medical images displayed at the same time, 3D rendering, the results of additional processing, such as a computer aided diagnosis (CAD), and/or the like.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A messenger-based medical image sharing method, comprising:
selecting, by a processor, at a first viewer, at least one second user with whom a first medical image displayed on a screen will be shared via a messenger;
synchronizing, by the processor, the first viewer with a second viewer of the selected second user via the messenger;
providing, by the processor, at the first viewer, the second viewer with information about a link to the first medical image displayed on the first viewer via the messenger so that the second viewer can receive the first medical image from a medical image server which provides medical images; and
sharing, by the processor, the first medical image between the first viewer and the second viewer via the messenger.

2. The messenger-based medical image sharing method of claim 1, wherein the sharing further includes sharing text or voice input via any one of the two viewers with the other viewer via the messenger.

3. The messenger-based medical image sharing method of claim 1, further comprising, once the first medical image has been shared, controlling, by the processor, the second viewer via the messenger so that a first user input of the first viewer can be applied to the first medical image displayed on the second viewer.

4. The messenger-based medical image sharing method of claim 1, further comprising, once the first medical image has been shared, controlling, by the processor, via the messenger so that a user input of any one of the first and second viewers can be applied to the first medical image displayed on the other viewer together.

5. The messenger-based medical image sharing method of claim 4, wherein the controlling further includes, if a permission for a second user input to the first medical image has been preset, controlling, by the processor, via the messenger so that the input of the second user can be applied to the first viewer together.

6. The messenger-based medical image sharing method of claim 1, wherein the sharing further includes sharing the first medical image with the second viewer only within a range of information sharing set by a first user of the first viewer.

7. The messenger-based medical image sharing method of claim 1, wherein the selecting further includes selecting the second user from information of a plurality of users included in information about a group preset by the first user.

8. A messenger-based medical image sharing system, comprising:
a processor configured to:
select at least one second user with whom a first medical image displayed on a screen will be shared to be selected via a messenger provided in a first viewer;
synchronize the first viewer with a second viewer of the selected second user via the messenger;
provide the second viewer with information about a link to the first medical image via the messenger so that the second viewer can receive the first medical image from a medical image server for providing medical images; and
share the first medical image between the first viewer and the second viewer via the messenger.

9. The messenger-based medical image sharing system of claim 8, wherein the processor is further configured to share text or voice input by a first user of the first viewer with the second viewer via the messenger.

10. The messenger-based medical image sharing system of claim 8, wherein the processor is further configured to, once the first medical image has been shared, control the second viewer via the messenger so that a first user input of the first viewer is applied to the first medical image displayed on the second viewer together.

11. The messenger-based medical image sharing system of claim 8, wherein the processor is further configured to, when a second user input of the second viewer is received via the messenger, controls the first medical image displayed on the first viewer in accordance with the received second user input.

12. The messenger-based medical image sharing system of claim 8, wherein the processor is further configured to share the first medical image with the second viewer only within a range of information set by a first user of the first viewer.

13. The messenger-based medical image sharing system of claim 8, wherein the processor is further configured to select the second user to be selected from information of a plurality of users included in information about a group preset by the first user.

14. A messenger-based medical image sharing system, comprising:
a first viewer configured to:
include a first messenger; and
transmit information about a link to a first medical image displayed on a screen via the first messenger;
a second viewer configured to:
include a second messenger; and
receive the information about a link from the first viewer via the first and second messengers and share the first medical image; and
a medical image server configured to provide the first medical image corresponding to the information about a link to the second viewer.
